(19) United States
(12) Patent Application Publication
(10) Pub. No.: US 2015/0034731 A1
(43) Pub. Date: Feb. 5, 2015

(54) RAILROAD SPIKE FOR ATTACHING A METAL RAIL TO A WOODEN TIE

(71) Applicant: Peter M. Jackson, Shaker Heights, OH (US)

(72) Inventor: Peter M. Jackson, Shaker Heights, OH (US)

(73) Assignee: HEXAGON INDUSTRIES, INC., Cleveland, OH (US)

(21) Appl. No.: 14/450,983

(22) Filed: Aug. 4, 2014

Related U.S. Application Data
(60) Provisional application No. 61/862,247, filed on Aug. 5, 2013.
(60) Provisional application No. 61/913,017, filed on Dec. 6, 2013.

(51) Int. Cl. E01B 9/06; F16B 25/00

(52) U.S. Cl. CPC E01B 9/06; F16B 25/0015
USPC 238/372; 238/366

(57) ABSTRACT

A railway spike for connecting an associated metal member with an associated wood member includes a head including an annular flange and a standoff extending axially from the flange. An intermediate section extends axially from the standoff. At least one holding ring is disposed on the intermediate section. The at least one holding ring extends radially away from the intermediate section and is adapted to engage the associated wood member. A shank extends axially from the standoff. The shank includes a thread which is adapted to engage the associated wood member.

This application claims the benefit of U.S. Provisional Application Ser. No. 61/862,247, filed on Aug. 5, 2013, and the benefit of U.S. Provisional Application Ser. No. 61/913,017, filed on Dec. 6, 2013. The subject matter of each of these applications is incorporated herein in its entirety.

This disclosure relates to fasteners for securing a metal member to a wood member. More particularly, it relates to an improved railroad spike for attaching a metal rail to a wooden tie.

### BACKGROUND

It is common in constructing railway tracks to provide rails supported on cross ties which are formed of wood. The rails themselves are commonly made of a metal, such as steel. The rails are generally provided with mounting flanges which are adapted to rest on metallic bearing plates. These are commonly referred to as tie plates. The tie plates, in turn, rest on wooden ties. Spikes are employed for securing the tie plates, and hence the rails, to the ties. Generally, a spike is inserted through an opening in the tie plate with the spike shank being driven into the wooden tie. The head of the spike engages with a mounting flange of the rail, thereby securing the rail to the tie. Alternatively, the tie plate can be equipped with a metal clip or boss that engages to the flange of the rail. In this case, the head of the spike is adapted to engage the tie plate in order to secure the rail to the tie.

There are two known types of railroad spikes. The first of these is called a “track spike” or a standard or square spike. The second type of railroad tie is called a “screw spike” which has a threaded shank and is generally used only in more critical applications. Basic square shank track spikes are the most commonly used spikes in U.S. railroads. They tend to fit somewhat loosely in the hole in the wood tie and have almost no resistance to vertical separation between the tie plate and the wood tie. Track spikes are simply pounded into place. Screw spikes generally have threaded shanks to give a tighter or more secure fit of the rail/tie plate/ wood tie assembly. Such spikes are used in more critical sections of tracks, such as on curves, inclines, turnouts and the like. Screw spikes are generally screwed in with a clockwise rotation. However, if they have the proper thread pitch, they can either be screwed in or pounded in. In the following discussion, the term “spikes” refers strictly to screw spikes.

The known screw spikes often work loose from the tie after being in service for a period of time. This can occur for a variety of reasons. These include the deflection of the rail under the load of passing trains, as well as differential thermal expansion and contraction between the wood tie and the metal rail and plate, along with humidity changes and other environmental factors. Such loosening of the spike necessitates its replacement, and possibly the replacement of other parts of the track assembly. Attempts to secure or anchor the spike by providing the shank of the spike with burrs, barbs, serrations or other rough features adapted to engage with the wooden tie into which it is driven have generally proven unsatisfactory. One problem with such spikes is that it is difficult to drive them into the tie manually, or even using automated impact spike driving methods. Moreover, the spike may, during installation, chew or tear the wood fibers of the tie, thereby causing damage to the tie.

In addition, if the spikes have been in service for a length of time, they will have a tendency to “work”, i.e. move, in the hole established in the tie by the shank of the spike. This enlarges the hole in the tie surrounding the shank and damages the adjacent wood fibers, causing the spike to loosen in the tie over time. The enlarged hole is also disadvantageous because it permits water and various harmful chemicals to enter the hole in the wood, thereby further weakening the joint between the spike and the surrounding wood. Furthermore, removal of the spike usually causes additional damage to the tie. Spike removal most often requires replacement of the entire tie in order to ensure that the replacement spike will anchor the rail to the tie with adequate holding power.

It is known to provide railway spikes with threaded shanks which can be secured to a wooden tie. However, such spikes are difficult to install and generally require a predrilled hole in the tie to facilitate installation using rotary spike driving methods. Attempts have been made to equip spikes with tabs or uniquely shaped shanks meant to engage with the cavity of a tie plate, thereby locking the spike into engagement with the tie plate, thus reducing the tendency of the spike to work loose and damage the tie. However, such spikes are difficult to install using automated equipment and can generally be used only in conjunction with a particular tie plate design. Moreover, such spikes are extremely difficult to remove once locked into engagement with the tie plate that they are adapted to mate with.

A recently developed design which is meant to be an advance in the art employs a head having an annular flange, a standoff extending axially from the flange and a plurality of flutes extending axially from the standoff. The flutes are adapted to engage a wood tie. The standoff has a length adapted to ensure that the flutes are at least partially embedded in the wood when the spike is used to fasten a metal tie plate to a wooden tie. A shank extends axially from the flutes and terminates in a tapered tip. The shank comprises a plurality of helical generally parallel threads extending around the shank and running from the flutes to the tip.

However, there is still a need for an improved spike which is suitable for securing a metal rail to a wooden tie and which spike is better than the known spikes in a) resisting a rotational back out of the spike from the wooden tie and b) resisting a pull out of the spike from the wooden tie.

### BRIEF SUMMARY

In one embodiment of the present disclosure, a railway spike for connecting an associated metal member with an associated wood member comprises a head including an annular flange and a standoff extending axially from said flange. An intermediate section extends axially from the standoff. At least one annular holding ring is disposed on the intermediate section with the at least one holding ring adapted to engage the associated wood member. A shank extends axially from the standoff, said shank comprising a thread which is adapted to engage the associated wood member.

According to another embodiment of the present disclosure, a fastener is provided comprising a head including an annular flange which is adapted to engage an associated metal member and a standoff extending axially from the flange. An intermediate section extends axially from the standoff. The intermediate section has a diameter which is smaller than is a diameter of the standoff. At least one annular holding ring is disposed on the intermediate section and extends radially away therefrom. The at least one holding ring is adapted to engage an associated wood member and resist a backing out of the fastener from the associated wood member. The at least one holding ring includes a flat top surface oriented towards the standoff, the top surface being adapted to engage fibers of the associated wood member, and a tapered bottom surface. A shank extends axially from the standoff, the shank comprising a thread adapted to engage the associated wood member.

### BRIEF DESCRIPTION OF THE DRAWINGS

FIG. 1 is a perspective view of a typical metal to wood fastening application employing a spike according to one embodiment of the present disclosure;

FIG. 2 is an enlarged side elevational view of a spike according to one embodiment of the present disclosure;

FIG. 3 is a top plan view of the spike of FIG. 2;

FIG. 4 is a cross sectional view of the spike of FIG. 2 along the line 4-4;

FIG. 5 is an enlarged perspective view of a portion of the spike of FIG. 2;

FIG. 6 is an enlarged perspective view of a portion of a prior art spike;

FIG. 7 is a perspective view of a spike according to another embodiment of the present disclosure; and

FIG. 8 is a perspective view of a spike according to still another embodiment of the present disclosure.

### DETAILED DESCRIPTION

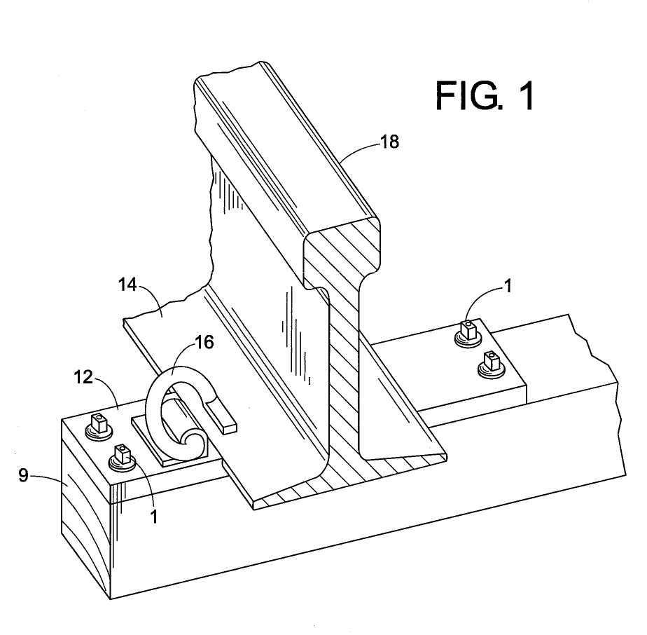

FIG. 1 illustrates a typical railway installation. More particularly, illustrated is a metal rail 18 which is fastened to a wood tie 9 using a fastener or spike 1 according to one embodiment of the present disclosure. A metal tie plate 12, including an elastic fastener 16, engages with a flange 14 of the metal rail 18. A plurality of such spikes 1 is inserted, each into a respective one of a plurality of apertures extending through the tie plate 12 in order to secure the tie plate 12, and hence the rail 18, to the tie 9.

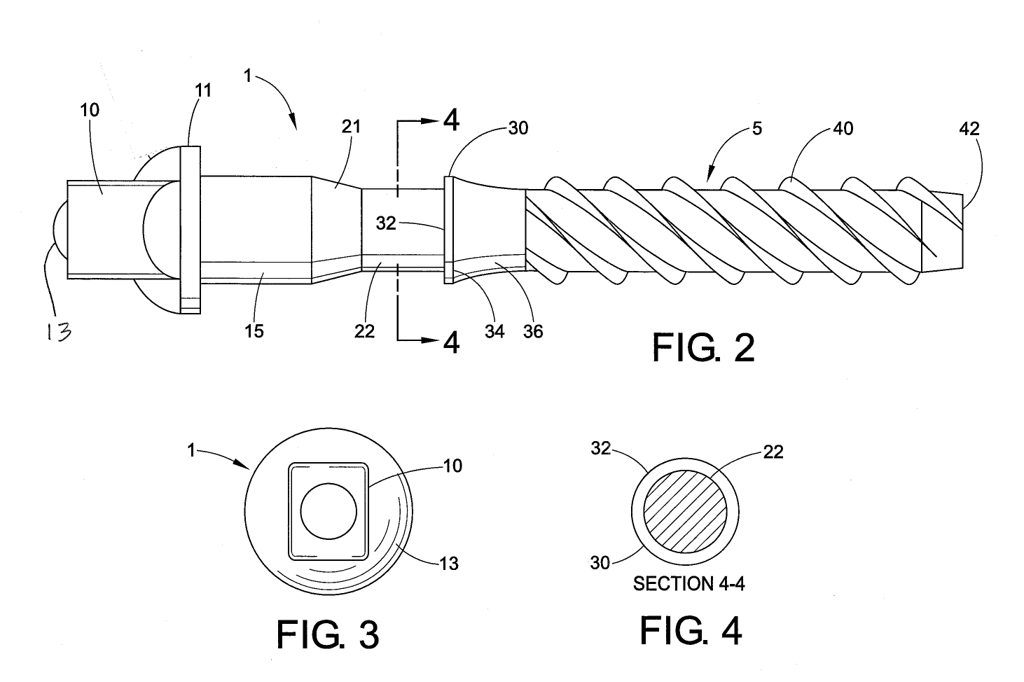

With reference now to FIG. 2, the spike 1 includes a head 10 comprising a first annular flange 11 and a standoff 15 extending axially away from the flange 11 in a direction opposite to a tool grip defined on the head 10. In this design, the standoff is generally cylindrical and does not include any protrusions, such as burrs, barbs, serrations, flutes or similar rough features. Extending axially from the standoff 15 is a shank 5. Disposed between the shank and the standoff is a tapered end section 21 of the standoff. The tapered end section 21 has a larger diameter end mating with the standoff and a smaller diameter end mating with an end section 22 of the shank. It is noted that the shank 5 has a reduced diameter in relation to the standoff 15. The end section 22 leads to a second annular flange 30. The second flange includes a flat top surface 32 facing the standoff 15 and a bottom surface 34 which merges into a tapered intermediate section 36 which leads to a threaded portion of the shank 5. The shank exhibits one or more pitched helical generally parallel threads 40 extending from a smaller diameter end of the tapered section 36 (which can be the same as the minor diameter of the threads 40) to a tip 42 of the spike 1. The tip 42 may have a reduced diameter in relation to a diameter of the shank 5.

As is known, the head 10 can comprise a projecting polygonal tool grip extending axially from the first flange 11 on the side opposite the standoff 15. The tool grip is generally adapted for engagement by a known wrench (not shown) to enable rotary driving of the spike into the tie. The head can also be employed for removal of the spike using a reverse rotary motion imparted to the tool grip. The head 10 can include a hemispherical portion 13 which allows the driving of the spike into the wooden tie, as is known in the art. Also known in the art is that the head can be deformed somewhat in the area of the hemispherical portion as it is driven into the wooden tie, thereby preventing damage to the tool grip because that could prevent removal of the spike when employing a wrench.

The one or more pitched helical threads 40 permit the driving of the spike 1 into the tie 9 using a generally clockwise rotary motion applied to the tool grip 10. This design is well suited for use with automated spike driving equipment, as well as a manual driving of the spike into the wooden tie.

The diameter and overall length of the spike may be varied according to the dimensions of the wooden tie, as well as the dimensions of the metallic tie plate. Generally, however, the length of the spike is in the range of 10 to 20 cm. As is known, the spike is made of a suitable conventional metal.

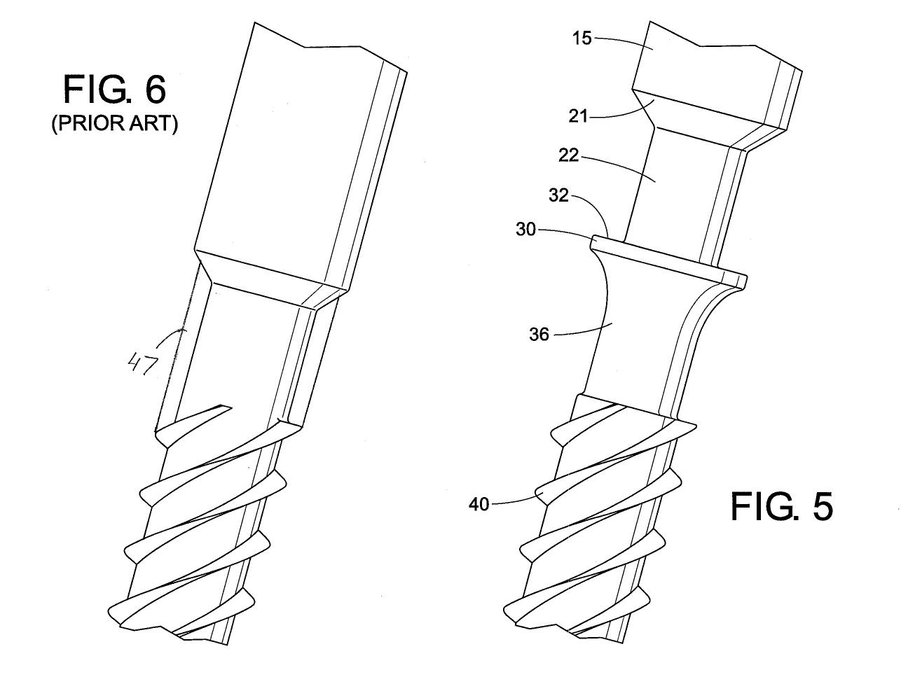

In this embodiment, neither the tapered end section 21, nor the tapered intermediate section 36 of the spike, have any burrs, barbs, serrations, flutes, threads or any other rough feature which would be adapted to engage with the wooden tie. Rather, all of the tapered section 21, the reduced diameter section 22 and the tapered intermediate section 36 have a generally smooth outer periphery, as can be seen in the perspective view of FIG. 5, as well as the cross sectional view of FIG. 4, for the reduced diameter section 22. It was thought that the spike disclosed in FIGS. 2 and 5 was more resistant to removal, than is the known spike having flutes 47 illustrated in FIG. 6.

In another design, it would be conceivable to add an additional flange or holding ring located adjacent the second flange 30 and this may also enhance the holding power of the spike in the wooden tie. It would also be conceivable to add a rib or flute to the tapered end section 21 of the fastener. However, only testing will demonstrate whether the addition of one or more such ribs or flutes to the tapered end section 21 will be beneficial or detrimental to either a pull out resistance or a torque resistance of the spike. Similarly, perhaps flute(s) or rib(s) could be located on the tapered section 36.

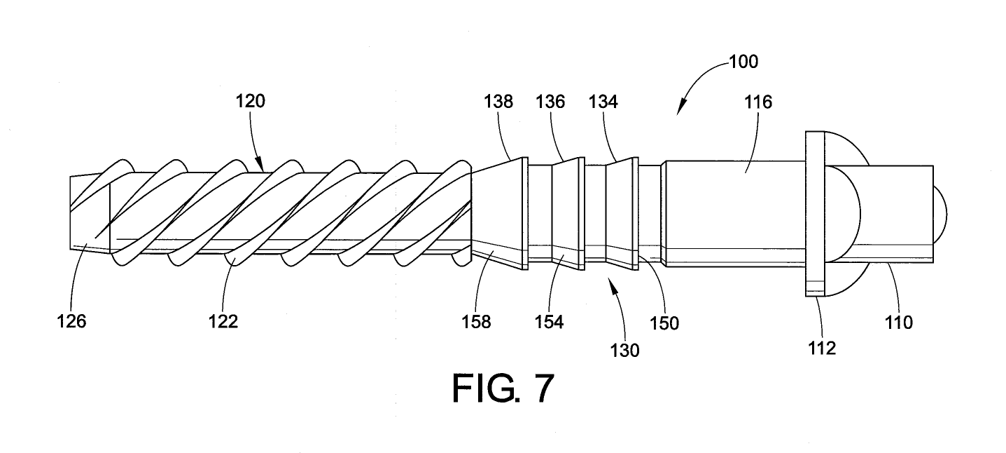

With reference now to FIG. 7, another embodiment of the present disclosure pertains to a spike 100 which includes a head 110 located at one end. Located adjacent to the head is a flange 112. A standoff 116 extends axially away from the flange 112 in a direction opposite to a tool grip defined on the head 110. Extending along the axis of the standoff 116 is a shank 120. Disposed on the shank is one or more threads or flutes 122. The shank can terminate in a tip 126 which may be tapered so as to have a smaller diameter than the shank. Disposed between the standoff 116 and the shank 120 is an intermediate section 130 of the spike. The intermediate section comprises a plurality of spaced annular holding rings 134, 136 and 138. In this embodiment, three such holding rings are employed. Each holding ring includes a flat top surface 150 and a tapered bottom surface. The first two holding rings have identical tapered bottom surfaces 154 whereas the third holding ring 138 has an elongated tapered bottom surface 158 which leads to the threaded or fluted section of the spike. The taper angle of the bottom surface 158 can be about 35°. All three bottom surfaces 134, 154 and 158 can have the same taper angle, if desired. Alternatively, they can have different taper angles. Because the third bottom surface 158 is elongated, it should be apparent that the diameter of the shank 120 is smaller than is the diameter of the intermediate section 130 in this embodiment.

In this embodiment, three holding rings or annular flanges are disposed in a spaced manner on the spike such that they are located between the head 110 and the one or more threads 122. During testing, the configuration illustrated in FIG. 7 appeared to perform well under most conditions experienced by wooden railroad ties even if they are made of varying types of wood. The spike of FIG. 7 performed well in harder woods, such as hard maple, but also in softer woods, such as red oak, as long as the softer woods were heavily saturated with creosote. It has been found that there is a significant difference between red oak, white oak, ash, hard maple and even batches of red oak in terms of the ability of the spike to stay firmly attached to the railroad tie and not work its way out. It has been found that the presence of several annular flanges may completely stop the spike from backing out of the railway tie. In the current set of tests, the spike according to FIG. 7 basically stripped in place after coming out less than one half of an inch; back out was essentially stopped at that distance of removal. This is of critical importance because if the spike does not continue to back out, it's primary intended functionality (holding power) will not continue to degrade, as happens with spikes of the prior art.

In the known design of FIG. 6, the loss of back out resistance is virtually immediate once back out of the spike starts. It is believed that the reason for this is that the holding feature, i.e., the flutes illustrated in FIG. 6, come out of the wood almost immediately. In contrast, in the designs according to the instant disclosure, the holding rings remain embedded in the wooden tie for a longer period of time, and in fact typically never leave the wood.

It has been found through testing that as the spike backs out of the railway tie, its hold down strength is reduced. However, due to the presence of the several holding rings in the embodiment illustrated in FIG. 7, for example, the spike does not back out and therefore always has a significant minimum hold down strength.

In one embodiment, the outer diameter of the holding rings was about 0.965 to about 0.975 inches. In contrast, the inner diameter, i.e. the diameter of the intermediate section 130 was about 0.845 to about 0.855 inches. Another consideration is the ratio of the outer and inner diameters of the holding rings disposed on the fastener or spike. In this embodiment it is in the range of about 1.15 to 1. The ratio is considered significant in order to get the right amount of “pack” of the wood fibers in the tie between the several flanges or holding rings in order to retard, and hopefully completely prevent, the backing out of the screw spike from the wood tie into which it has been inserted. The distance between the several holding rings 134, 136, 138 can be on the order of 0.43 inches. In one embodiment, the diameter of the shank can be about 0.71 inches.

Another important consideration of the design of the holding rings is that the outside diameter be large enough to create sufficient holding and anti-back out force, but small enough that the threads are able to pull them fully into the wood tie during installation.

The number of flanges or holding rings is limited by the thickness of the wooden tie and the length of the threaded portion or fluted portion of the fastener in a particular application, i.e. the length of the shank. Two flanges work very well in most applications using most wood types. However, three flanges appear desirable in an application where at least some of the ties are made of a softer wood. Four or more flanges might work well with a fastener or spike length that allows enough spacing between the flanges or holding rings. In one embodiment, the spacing between the flanges is on the order of about 0.488 inches.

Another important consideration is the thread length, i.e. the length of the shank containing the thread of the fastener or spike. The thread length has to be long enough to get full holding power as the spike is driven into the wooden tie. However, the thread length has to be short enough to not overcome the holding power exerted by the holding rings when the spike or fastener is in a back out mode. In one embodiment, the spike has a thread length of about 3.5 inches. In that embodiment, the length of the intermediate section 130 and the standoff 116, but not including the flange 112 or the head 110, is about 3.1 inches.

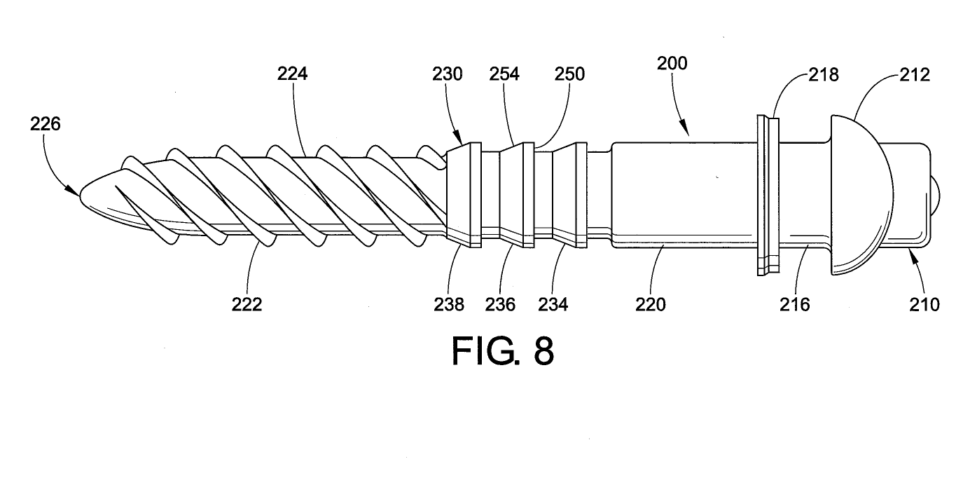

With reference now to FIG. 8, another embodiment of a spike 200 is there illustrated. In this embodiment, the spike has a head 210 and a first flange 212 located immediately below the head. Also provided is a first standoff section 216 which terminates in a second flange 218 spaced from the first flange 212. Extending from the second flange 218 is a second standoff section 220. The spike 200 also includes a thread 222 defined on a shank 224 and terminating in a pointed tip 226.

Located between the second standoff section 220 and the shank 224 is an intermediate section 230 of the spike 200. Defined on the intermediate section 230 are a plurality of holding rings. In this embodiment, three rings 234, 236 and 238 are spaced along the intermediate section 230. Each holding ring or flange includes a flat top surface 250 and a tapered or angled bottom surface 254.

The spike illustrated in FIG. 8 may be useful in an environment where for maintenance or other reasons a pullout feature is required for the intentional removal of a spike. More particularly, a pull out tool can be inserted between the first and second flanges 212 and 218. This embodiment of the fastener or spike provides a gripping surface for the pull out tool allowing the spike to be pulled out against the resistance of the plurality of holding rings defined on the intermediate section 230 of the spike.

In the embodiments of FIGS. 7 and 8, the spike includes threads leading from the intermediate section to the tip. But the intermediate section and the standoff do not have any threads or flutes. The increased or enhanced back out and pullout resistance of the spike of the present disclosure has two components. First, there is an increased back out resistance that typically leads to a maximum back out of approx. ½″.Second, because the back out process of the embodiments of FIGS. 7 and 8 typically stop at ½″ or less, it's hold down power and overall performance is retained at that level; because the design shown in FIG. 6 and other prior art will continue to back out, their hold down force and overall performance will continue to degrade.

What is important is to ensure that the spike is driven far enough into the wooden tie that the flanges or holding rings become well embedded in the tie. It is believed that the ability of the wood fibers in the tie to spring back on the flat side of the respective holding ring after the spike is driven into the tie is better with the designs shown in FIGS. 7 and 8. One reason is because there are no flutes in the area of the intermediate section of the spike interfering with the ability of the wooden fibers to spring back and lock the flanges or holding rings in place. This is likely due to the flat upper faces of the respective flanges or holding rings. It is believed that one of the reasons for the improvements in the disclosed spike designs is because the flat upper surfaces of the annular flanges or holding rings more directly oppose both a vertical pull out, as well as a reverse rotational back out of the spike from a wooden tie than does the design illustrated in FIG. 6.

With additional testing having been conducted on the design illustrated in FIGS. 2 and 5 of the instant application, it was found that the pull out force, i.e. a straight pull out, like a tensile test, is remarkably similar between almost all known thread types and also the known anti-back out features, such as the prior art design illustrated in FIG. 6. This result also applied to the anti-back out feature or second flange illustrated in FIGS. 2 and 5. However, the use of a plurality of spaced holding rings if properly configured as discussed previously and as illustrated, for example, in FIGS. 7 and 8, does succeed in at least retarding, if not completely preventing, any back out of the spike from the wooden tie that it is driven into. If the spike does not back out, neither its hold down force nor its pull out resistance are compromised. As mentioned previously, with a railway tie made of a hard wood, perhaps even two holding rings would be adequate. A third holding ring is desirable, however, when the spike is employed with a softer type of wood, such as red oak.

In yet another embodiment, it would be possible to define the holding ring or holding rings such that while they are annular and extend all the way around the intermediate section of the spike, the holding rings can be provided with notches or recesses arranged along the periphery of the holding rings. These notches can be spaced at equal distances. This arrangement may allow the spike to more easily penetrate the wood when the spike is driven into the railway tie. Alternatively, conical recesses can be provided on the bottom surface of the holding ring for a similar purpose.

The present disclosure has been described with reference to several embodiments. Obviously, modifications and alterations will occur to others upon a reading and understanding of the preceding detailed description. It is intended that the present disclosure be construed as including all such modifications and alterations insofar as they come within the scope of the appended claims or the equivalents thereof.

What is claimed:

1. A rail spike for connecting an associated metal member with an associated wood member comprising:
a head including an annular flange;
a standoff extending axially from said flange;
an intermediate section extending axially from said standoff;
at least one annular holding ring disposed on said intermediate section and extending radially away therefrom, said at least one holding ring adapted to engage the associated wood member; and
a shank extending axially from said standoff, said shank comprising a thread which is adapted to engage the associated wood member.

2. The spike of claim 1 further comprising a reduced diameter tip located on a distal end of the shank.

3. The spike of claim 1 comprising two axially spaced holding rings which are located on the intermediate section.

4. The spike of claim 3 wherein the two holding rings each comprise a flat top surface facing said standoff and a tapered bottom surface facing said shank.

5. The spike of claim 4 wherein the tapered bottom surfaces of the two holding rings have different taper angles.

6. The spike of claim 1 wherein the at least one holding ring has a diameter which is larger than is a diameter of said intermediate section.

7. The spike of claim 6 wherein the diameter of the at least one holding ring is smaller than is a diameter of said annular flange of said head.

8. The spike of claim 7 wherein the diameter of the at least one holding ring is approximately equal to a diameter of the standoff.

9. The spike of claim 6 wherein the diameter of the at least one holding ring is larger than is a diameter of said thread disposed on said shank.

10. The spike of claim 1 wherein the at least one holding ring comprises a flat top surface facing said standoff and a tapered bottom surface facing said shank.

11. The spike of claim 1 further comprising a second flange disposed on said standoff, wherein said second flange is spaced from said annular flange.

12. The spike of claim 1 wherein a diameter of said standoff is larger than is a diameter of said intermediate section.

13. A fastener comprising:
a head including an annular flange adapted to engage an associated metal member;
a standoff extending axially from said flange;
an intermediate section extending axially from said standoff, wherein said intermediate section has a diameter which is smaller than is a diameter of said standoff;
at least one annular holding ring disposed on said intermediate section and extending radially away therefrom, said at least one holding ring adapted to engage an associated wood member and resist a backing out of the fastener from the associated wood member, wherein the at least one holding ring includes a flat top surface oriented towards said standoff, the top surface being adapted to engage wood fibers of the associated wood member, and a tapered bottom surface; and
a shank extending axially from the standoff, the shank comprising a thread adapted to engage the associated wood member.

14. The fastener of claim 13 comprising two holding rings which are disposed in an axially spaced manner and are located on the intermediate section.

15. The spike of claim 14 wherein each of the two holding rings include flat top surfaces and tapered bottom surfaces.

16. The spike of claim 15 wherein the bottom surfaces of the two holding rings have different taper angles.

17. The spike of claim 13 wherein the diameter of the at least one holding ring is smaller than is a diameter of said annular flange of said head.

18. The spike of claim 13 wherein a diameter of the at least one holding ring is larger than is a diameter of said thread disposed on said shank.

19. The spike of claim 13 further comprising a second flange disposed on said standoff wherein said second flange is disposed in a spaced relationship to said annular flange.

20. The spike of claim 13 wherein the diameter of the at least one holding ring is approximately equal to a diameter of the standoff.
